(19) United States
(12) Patent Application Publication
(10) Pub. No.: US 2021/0158189 A1
(43) Pub. Date: May 27, 2021

(54) ELECTRONIC DEVICE AND A METHOD FOR CONTROLLING A CONFIGURATION PARAMETER FOR AN ELECTRONIC DEVICE

(71) Applicant: Sony Corporation, Tokyo (JP)

(72) Inventors: Hannes BERGKVIST, Helsingborg (SE); Peter EXNER, Malmö (SE)

(21) Appl. No.: 17/079,918

(22) Filed: Oct. 26, 2020

(30) Foreign Application Priority Data
Nov. 26, 2019 (SE) 1951353-0

(51) Int. Cl. G06N 5/04; G06F 1/26

(52) U.S. Cl. CPC G06N 5/04; G06F 1/26

(57) ABSTRACT

An electronic device includes a memory circuitry, an interface circuitry, a processor circuitry having a controller circuitry, and an inference circuitry configured to operate according to a first inference model of a plurality of inference models. The processor circuitry is configured to obtain first primary detection data from a detection circuitry. The processor circuitry is configured to obtain one or more criteria. The processor circuitry is configured to obtain, from the inference circuitry, a first primary probability associated with the first primary detection data, based on the first inference model. The processor circuitry is configured to generate a first set, based on the one or more criteria, by determining whether the first primary probability associated with the first primary detection data satisfies at least one of the one or more criteria.

### RELATED APPLICATION DATA

This application claims the benefit of Swedish Patent Application No. 1951353-0, filed Nov. 26, 2019, the disclosure of which is incorporated herein by reference in its entirety.

### TECHNICAL FIELD

The present disclosure pertains to the field of Internet of things and relates to an electronic device and to a method for controlling a configuration parameter for an electronic device.

### BACKGROUND

Power optimization is a challenging aspect of the design of electronic devices such as connected devices and Internet of things, IoT, devices. It may be challenging to reduce energy consumption of electronic devices for example to ensure that a battery powered electronic device may be working for its intended operation time. Many electronic devices comprise detectors that are configured to be controlled. These detectors usually have a dormant state of low power consumption until an event occurs. A common scenario is that an electronic device sleeps until a detection occurs, and then performs some processing of data obtained from the detectors.

For some applications, electronic devices are configured to be in a continuous operation mode (such as continuous detection mode). The continuous detection mode requires also requires a continuous energy consumption which may result in a high energy consumption.

An example of such an electronic device is an electronic device for surveillance applications. For surveillance applications, it is desirable to the have the highest possible detection accuracy while keeping a high rate of detection (such as frame rate) in order not to miss detections in a changing scene. Additionally, in remote environments where a fixed power supply is not available or in contexts when battery replacement/recharging is cumbersome, it is desirable to run the detection with the least energy consumption (for example with a low power consumption profile).

The environment being monitored by the electronic device for surveillance applications may have a high variety in activity. As an example, in surveillance, crowds with people or vehicles may suddenly gather during rush hour while the scene may be relatively static during off hours. Similarly, production lines in a factory may run at peak levels only during certain periods as dictated by the operation of the factory. It is therefore challenging for an electronic device to control a detector in such environments.

A controlling of the detector may be determined by a series of configuration parameters. These configuration parameters are tuned manually to achieve a tradeoff between accuracy of detection (higher power consumption for higher accuracy) and rate of detection (missing relevant events). It may be challenging and time consuming to tune these configuration parameters and it requires expert level competence. The results are often less than optimal due to differences in the lab environment compared to the real life conditions or deployment environment. It may be challenging to foresee and adjust for every possible detector situation.

### SUMMARY

It is known in the field that increasing input complexity of detection requires increasing model complexity in the electronic device in order to have high accuracy levels. As an example, surveillance images with multiple people presents situations where more people are occluded thereby requiring a more complex model for accurate scene detection and understanding.

However, more accurate models have increasing computational complexity and therefore increasing power consumption (for example requiring more power consumption per inference).

Furthermore, inference speed is inversely related to detection accuracy.

An approach could be to use an initially small model (with low model complexity) to detect a change in the environment, such as motion, and when detected, activate a larger model (with higher model complexity) to perform the detection.

This may allow to keep power consumption low while the scene is static and the electronic device is idle.

However, one shortcoming of such an approach is that it enables only one accuracy level, one fixed framerate of detection, and one power usage level, determined by the complexity of the larger model.

Accordingly, there is a need for electronic devices and methods for controlling a configuration parameter for an electronic device which mitigate, alleviate or address the shortcomings existing and provide a more reliable, dynamic and precise controlling of a configuration parameter for an electronic device.

The present disclosure provides an electronic device. The electronic device comprises a memory circuitry, an interface circuitry, a processor circuitry comprising a controller circuitry, and an inference circuitry configured to operate according to a first inference model of a plurality of inference models. The processor circuitry is configured to obtain first primary detection data from a detection circuitry. The processor circuitry is configured to obtain one or more criteria. The processor circuitry is configured to obtain, from the inference circuitry, a first primary probability associated with the first primary detection data, based on the first inference model. The processor circuitry is configured to generate a first set, based on the one or more criteria, by determining whether the first primary probability associated with the first primary detection data satisfies at least one of the one or more criteria. The processor circuitry is configured to obtain a first error data based on the first set. The processor circuitry is configured to control, using the controller circuitry, based on the first error data, a configuration parameter indicative of one of the plurality of inference models for provision to the inference circuitry.

Further, a method for controlling a configuration parameter for an electronic device is provided. The electronic device comprises a memory circuitry, an interface circuitry, and a processor circuitry comprising a controller circuitry, an inference circuitry configured to operate according to a plurality of inference models comprising a first inference model. The method comprises obtaining first primary detection data from a detection circuitry. The method comprises obtaining one or more criteria. The method comprises obtaining, from the inference circuitry, a first primary probability associated with the first primary detection data, based on the first inference model. The method comprises generating a first set, based on the one or more criteria, by determining whether the first primary probability associated with the first primary detection data satisfies at least one of the one or more criteria. The method comprises obtaining a first error data based on the first set and controlling, using the controller circuitry, based on the first error data, a configuration parameter indicative of one of the plurality of inference models for provision to the inference circuitry.

It is an advantage of the present disclosure that the power consumption of the electronic device may be reduced. This may be achieved by optimizing a configuration parameter to reduce unnecessary computationally intensive inference models used for the processing at the electronic device.

The above advantages may provide a more reliable and more precise electronic device and provision of configuration parameters for detection circuitries operatively coupled with the electronic device. In other words, the disclosed electronic device and method allow on-device, continuous adaptation and optimization of the configuration parameter indicative of one of the plurality of inference models for provision to the inference circuitry (for example the complexity of an inference model) by exploiting the controller circuitry and the inference circuitry.

When an input complexity of the first primary detection data increases (for example a more complex scene where more people move in an image), the disclosed electronic device (for example via controller circuitry) controls a configuration parameter indicative of one of the plurality of inference models for provision to the inference circuitry (for example selects an increasingly complex inference model until a probability threshold has been reached). An advantage of this, is that the electronic device may control the configuration parameter to adapt to a more complex first primary detection data, thereby allowing an accurate detection of more complex first primary detection data when it is required.

When a detection scene is static (for example if there are no people in the scene), the electronic device (for example via controller circuitry) controls a configuration parameter indicative of one of the plurality of inference models for provision to the inference circuitry (for example selects a decreasingly complex inference model until for example an idle power mode of the electronic device is reached, and/or for example select the least complex inference model resulting in the electronic device being in idle power mode).

A further advantage of the present disclosure is that in an environment that varies in complexity (for example event occurrence or number of objects per scene), the present solution controls a configuration parameter indicative of one of the plurality of inference models for provision to the inference circuitry (for example selects the minimal complexity of a model in order to keep the power consumption as low as possible, while assuring that model performance is kept at an acceptable level).

A further advantage is that, by keeping the complexity of the inference model as low as possible, the inference speed or rate of detection runs faster. For example, in scenes with many changes, this means that it becomes less probable that a detection is missed.

### BRIEF DESCRIPTION OF THE DRAWINGS

The above and other features and advantages of the present disclosure will become readily apparent to those skilled in the art by the following detailed description of example embodiments thereof with reference to the attached drawings, in which:

FIGS. 1A-B are block diagrams illustrating example electronic devices according to one or more embodiments of this disclosure,

FIGS. 2A-C are flow-charts illustrating an example method, for controlling a configuration parameter for an electronic device according to one or more embodiments of the present disclosure,

FIG. 3 is a schematic representation illustrating an example where a configuration parameter is controlled according to one or more embodiments of this disclosure, and

FIG. 4 is a schematic representation illustrating an example for controlling a configuration parameter for an electronic device according to one or more embodiments of this disclosure.

### DETAILED DESCRIPTION

Various example embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

The figures are schematic and simplified for clarity, and they merely show details which aid understanding the disclosure, while other details have been left out. Throughout, the same reference numerals are used for identical or corresponding parts.

A set of n inference models, with increasing complexity, such as increasing depth of neural networks or architecture, are deployed in electronic devices, such as an IoT device storage. The complexity of the inference models correlates with a higher number of calculations in order to perform a single inference, e.g. a detection of an object in an image. The increased computation also translates to a higher power consumption needed per inference. It may be appreciated that as the complexity level of the inference model increases, the accuracy of the inference may increase, the computational power may increase and the power consumption may increase while the inference speed may decrease. The present disclosure allows achieving acceptable accuracy, at acceptable power consumption and acceptable computational power by adapting the selection of the inference model based on one or more criteria.

The present disclosure permits keeping the power consumption as low as possible, while achieving a performance of the detection at an acceptable high level.

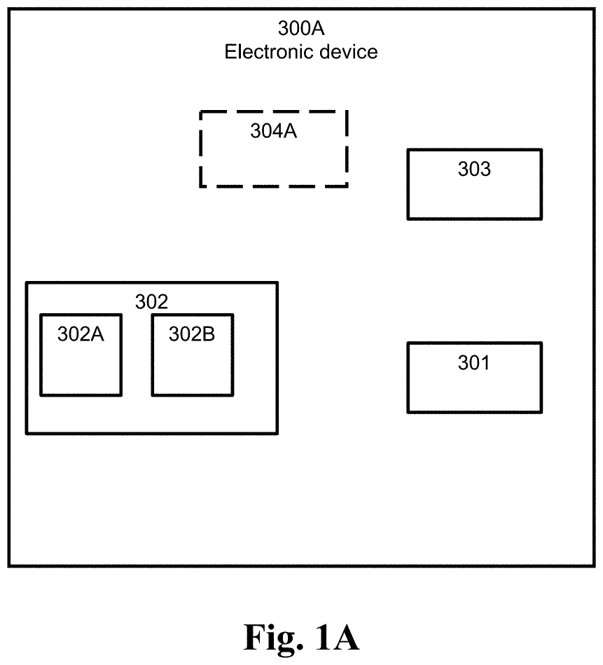

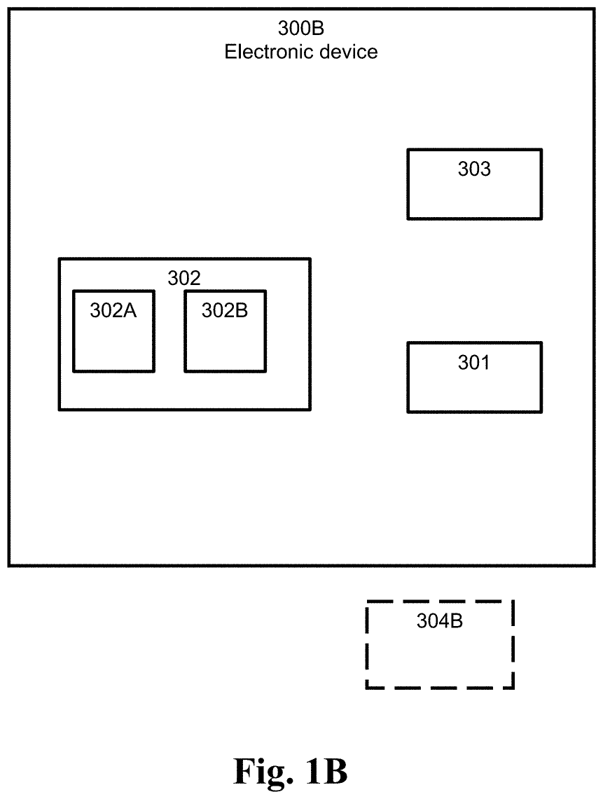

FIG. 1A is a block diagram illustrating an example electronic device 300A according to some embodiments of the present disclosure.

The electronic device 300A may for example comprise a portable electronic device, a wireless device, and/or an IoT device.

The electronic device 300A comprises a memory circuitry 301, an interface circuitry 303, and a processor circuitry 302.

The processor circuitry 302 comprises a controller circuitry 302A and an inference circuitry 302B configured to operate according to a first inference model of a plurality of inference models. The inference circuitry 302B may be seen as an inference engine configured to perform an inference (such as an inference derivation, such as a statistical inference, such as a statistical inference derivation) such as based on an inference model and input data (such as first primary detection data).

The first inference model may be an initial inference model of an initial complexity defined on the inference circuitry. The initial inference model may be embedded on the inference circuitry before performing a first inference cycle in response to a detection. The initial complexity may depend on the application or the environment that the electronic device is used in.

The processor circuitry 302 is configured to obtain first primary detection data from a detection circuitry 304A. The first primary detection data may be indicative of a detection event or a non-detection event (for example, the detection of one or more objects, one or more persons, and/or one or more vehicles). In one or more example electronic devices, the detection circuitry 304A is internal to the electronic device 300A. In other words, the electronic device 300A may comprise the detection circuitry 304A. The first primary detection data may be data such as optical data (such as photo or video) from a detection circuitry such as a camera, accelerometer data from a detection circuitry such as an accelerometer, light data from a photo-detector, sound (such as voice) data from a microphone, temperature data from a thermometer, pressure data from a pressure detection, and/or humidity data from a hygrometer. For example, the first primary detection data may be based on a primary image captured by a first camera.

The first primary detection data may for example comprise one or more detections comprised in one frame. An inference cycle may be performed for each frame, more than once per frame, or less than once per frame.

Optionally, the detection circuitry may comprise one or more of: a camera, an accelerometer, a photo-detector, a microphone, a thermometer, a pressure detector, and a hygrometer. For example, the detection circuitry may be set to generate detection data (e.g. the first primary detection data). The detection data may be associated with one or more events at one or more thresholds (such as the smallest threshold possible).

In some embodiments, the processor circuitry 302 may be configured to obtain first primary detection data and first secondary detection data from the detection circuitry 304A acting as a first detection circuitry (such as first primary optical data being indicative of for example an image of a scene, and first secondary optical data being indicative of for example a timestamp of the image, such as a time of capture of the image).

In some embodiments, the processor circuitry 302 may be configured to obtain first primary detection data from the detection circuitry 304A acting as a first detection circuitry (such as first primary optical data, being for example a first image of a scene from a first camera) and second primary detection data from a second detection circuitry (such as second primary sound data, being for example a first sound from a first microphone).

The processor circuitry 302 is configured to obtain one or more criteria (for example via the interface circuitry 303). The processor circuitry 302 is configured to obtain one or more criteria based on initial set up, such as by a user (for example a domain expert). The processor circuitry 302 is configured to obtain the one or more criteria using a cloud model, and/or another device. The one or more criteria may be defined as initial criteria such as initial conditions on which the electronic device operates. The one or more criteria may be user defined prior to the operation of the electronic device. The one or more criteria may be updated for example after performing a first inference cycle in response to a detection. The one or more criteria may depend on the application (such as type of detection) or the environment that the electronic device is used in. For example, the one or more criteria may comprise a probability threshold to be used for comparison with first primary probabilities associated with the first primary detection data to determine whether at least one of the one or more criteria is satisfied.

The processor circuitry 302 is configured to obtain, from the inference circuitry 302B, a first primary probability associated with the first primary detection data, based on the first inference model. In other words, the inference circuitry 302B may be configured to determine the first primary probability associated with the first primary detection data, based on the first inference model and the first primary detection data. The inference circuitry 302B may be configured to take the first primary detection data as input. The first primary probability may be seen as associated with the first inference model.

The first primary probability associated with the first primary detection data may for example comprise a probability of 0.8 that the first primary detection data is indicative of a car, a probability of 0.2 that the first primary detection data is indicative of a first person, and/or a probability of 0.5 that the first primary detection data is indicative of a second person.

The processor circuitry 302 is configured to generate a first set, based on the one or more criteria, by determining whether the first primary probability associated with the first primary detection data satisfies at least one of the one or more criteria. In other words, the one or more first primary probabilities associated with the first primary detection data may be partitioned in one or more sets (such as one or more partitions, such as one or more parts) depending the one or more first primary probabilities satisfying the at least one of the one or more criteria.

In some embodiments, the first set may be understood as a first partition. For example, the first set may comprise the first primary probability associated with the first primary detection data that satisfies at least one criterion, such as of having a first primary probability being below a probability threshold (for example 0.8).

The processor circuitry 302 is configured to obtain a first error data based on the first set. For example, the processor circuitry 302 is configured to obtain the first error data based on the first set, using the controller circuitry 302A. Stated differently, the controller circuitry 302A may be configured to generate the first error data based on the first set, such based on the one or more first primary probabilities associated with the first and the at least one of the one or more criteria. The first error data may be indicative of a difference between one of the one or more criteria and the first primary probability. The first error data may be indicative of how the controller circuitry is to control the configuration parameter indicative of one of the plurality of inference models for provision to the inference circuitry. In other words, the first error data may indicate how aggressively the controller circuitry is to control the configuration parameter (for example adjust a complexity level). In other words, the first error data may indicate how far from the one or more criteria is the currently applied first inference model. The first error data may be calculated when the first primary probability associated with the first primary detection data is below the probability threshold.

For example, the first error data may be seen as an error signal generated by the controller circuitry 302B which can be calculated as the difference between the probability threshold and either the minimum of the first primary probabilities of the first set or the maximum first primary probabilities of the first set. For example, when the first primary probabilities are zero, the error signal is set to zero in order to not raise the configuration parameter as output signal when the scene is empty. The configuration parameter output from the controller circuitry 302B is for example the k:th complex inference model to use.

The processor circuitry 302 is configured to control, using the controller circuitry 302A, based on the first error data, a configuration parameter indicative of one of the plurality of inference models for provision to the inference circuitry 302B. The configuration parameter may be seen as a parameter used to configure the inference model to be used by the inference circuitry 302B. For example, the configuration parameter may be seen as an inference configuration parameter. In some embodiments, the configuration parameter may be in the form of an inference model identifier. In some embodiments, the configuration parameter may indicate that inference model complexity and/or accuracy is to be decreased or increased.

It may be appreciated that the disclosed electronic device may advantageously benefit from a dynamic selection of inference models with varying complexity, using the controller circuitry, for achieving an improved or optimal inference performance with an improved power consumption.

In one or more example electronic devices, the processor circuitry 302 is configured to obtain using the controller circuitry 302A the first error data. In one or more example electronic devices, the controller circuitry 302A is configured to determine, based on the first error data, the configuration parameter indicative of the one of the plurality of inference models. In one or more example electronic devices, the controller circuitry 302A is configured to provide to the inference circuitry the configuration parameter. For example, the controller circuitry 302A (for example, a PID controller) may be configured to select is used to increasingly select the configuration parameter corresponding to an inference model which a higher or lower complexity until the at least one criterion is satisfied. For example, the controller circuitry 302A (for example, a PID controller) may be configured to increasingly indicate using the configuration parameter a more complex model to load into the GPU memory until a certain performance threshold has been reached. In some embodiments, the input to the controller circuitry 302A may comprise a measured first primary probability of the first inference model (for example the predicted probabilities of object types in an image detected by the current model) and a probability threshold (such as a set performance threshold, e.g. the minimum probability that is accepted for accuracy) to generate the first error data.

In one or more example electronic devices, the inference circuitry 302B is configured to apply the inference model corresponding to the provided configuration parameter.

In some embodiments, the inference circuitry 302B is configured to apply the inference model corresponding to the configuration parameter amongst the plurality of inference models. In other words, the inference circuitry 302B may be configured to change the first inference model to a second inference model corresponding to the configuration parameter.

In one or more example electronic devices, the generation of the first set is based on populating the first set for each first primary probability satisfying the at least one of the one or more criteria.

In other words, when there exists at least one first primary probability satisfying the at least one of the one or more criteria, the first set may be said to be populated with the at least one first primary probability, and the size of the first set is non-zero.

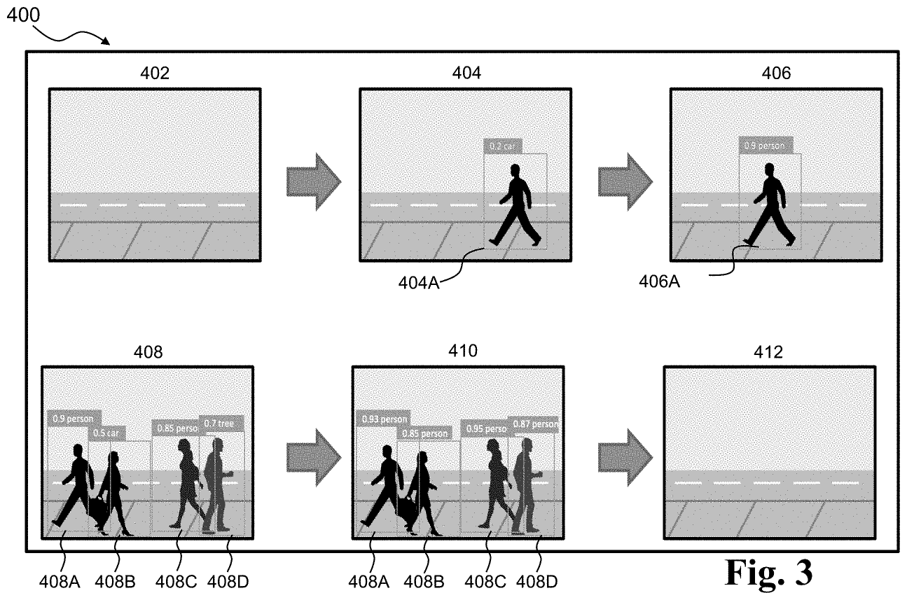

In some embodiments, the first set may comprise the one or more first primary probabilities associated with the first primary detection data that satisfies the at least one criterion of having a first primary probability of below a probability threshold (such as 0.8). The first set may thereby for example comprise the probability 0.2 of having an object detected as a car as illustrated in FIG. 3.

In one or more example electronic devices, the one or more criteria are based on a probability threshold and/or a detection category. In one or more example electronic devices, the one or more criteria are based on a probability threshold. In one or more example electronic devices, the one or more criteria are based on a detection category. In some embodiments, the first set may comprise one or more probabilities associated with the first primary detection data that satisfies the criterion of having a first primary probability of below the probability threshold. In some embodiments, the first set may comprise the one or probabilities associated with the first primary detection data that satisfies the criterion of matching the detection category. The detection category may comprise a first category indicative of a detection, a second category indicative of no detection.

In some embodiments, the generation of the first set is based on populating the first set for each first primary probability being below a first probability threshold and/or matching a first category.

In one or more example electronic devices, the first error data is obtained in response to the populating of the first set and based on the probability threshold and the first primary probability associated with the first set. In other words, the processor circuitry 302 is configured to, in response to the populating of the first set, determine the first error data based on the probability threshold and the first primary probability associated with the first set. Stated differently, when the first set is of a non-zero size, the processor circuitry 302 is configured to determine the first error data based on the probability threshold and the first primary probability associated with the first set.

In one or more example electronic devices, the first error data is obtained based on a difference between the probability threshold and a minimum first primary probability of the first set or a maximum first primary probability of the first set.

In one or more example electronic devices, the first error data is obtained based on a difference between the probability threshold and a minimum first primary probability of the first set. When the first error data is obtained based on the difference between the probability threshold and the minimum first primary probability of the first set, the controller circuitry 302A is for example configured to determine a configuration parameter corresponding to an inference model of increased complexity level but less aggressively. When the first error data is obtained based on the difference between the probability threshold and the maximum first primary probability of the first set, the controller circuitry 302A is for example configured to determine a configuration parameter corresponding to an inference model of increased complexity level but more aggressively.

When the first set is populated or includes only one first primary probability, then the one first primary probability serves as the minimum first primary probability and/or maximum first primary probability. In other words, the difference is between the probability threshold and the single first primary probability included in the first set.

In one or more example electronic devices, the processor circuitry 302 is configured to provide the obtained one or more criteria to the controller circuitry. In one or more example electronic devices, the configuration parameter is indicative of a complexity level of one of the plurality of inference models and/or indicative of an accuracy level of one of the plurality of inference models.

In other words, controlling the configuration parameter may result in selecting a higher complexity level, a lower complexity level, or in maintaining the same complexity level.

In one or more example electronic devices, the control of the configuration parameter indicative of the complexity level of one of the plurality of inference models is based on controlling a number of layers associated with an inference model and/or a layer type of the inference model. In one or more example electronic devices, the control of the configuration parameter is based on one or more of the following layer types: a convolutional layer, a pooling layer, a feedforward layer, a drop-out layer.

In one or more example electronic devices, the processor circuitry 302 is configured to generate a second set, based on one or more criteria, by determining whether the first primary probability associated with the first primary detection data does not satisfy the at least one of the one or more criteria.

In some embodiments, the second set may be understood as a second partition. For example, the second set may comprise the first primary probability associated with the first primary detection data that does not satisfies the criterion of having a first primary probability of below the probability threshold (such as 0.8). For example, when the first primary probability is equal or above the probability threshold, the first primary probability associated with the first primary detection data that does not satisfies the criterion of having a first primary probability of below the probability threshold.

In some embodiments, the second set may comprise one or more first primary probabilities associated with the first primary detection data that does not satisfy the criteria of having a first primary probability of below the probability threshold (such as 0.8). In other words, the second set may comprise one or more first primary probabilities associated with the first primary detection data that does not satisfy the criterion because the one or more first primary probabilities are equal or above the probability threshold (such as 0.8).

In one or more example electronic devices, the generation of the second set is based on populating the second set for each first primary probability not satisfying the at least one of the one or more criteria.

In one or more example electronic devices, the processor circuitry 302 is configured to obtain a second error data based on the second set.

In one or more example electronic devices, the second error data is obtained in response to the populating of the second set and based on the probability threshold and the first primary probability associated with the second set.

The second set may be said to be populated when the size of the first set is different from zero.

In one or more example electronic devices, the second error data is obtained based on a difference between the probability threshold and a minimum first primary probability of the second set or a maximum first primary probability of the second set.

In one or more example electronic devices, the processor circuitry 302 is configured to control, using the controller circuitry 302A, based on the second error data, a configuration parameter indicative of one of the plurality of inference models for provision to the inference circuitry 302A.

In one or more example electronic devices, the processor circuitry 302 is configured to determine whether the first primary detection data satisfies at least one criterion based on the detection category by determining whether the first primary detection data is not indicative of a detection.

In one or more example electronic devices, the processor circuitry 302 is configured to control, using the controller circuitry 302A, the configuration parameter indicative of one of the plurality of inference models with a decreased complexity level and/or a decreased accuracy level for provision at the inference circuitry 302B upon determining that the first primary detection data is not indicative of a detection.

In one or more example electronic devices, the processor circuitry 302 is configured to proceed to obtaining the first primary probability upon determining that the first primary detection data is indicative of a detection.

In one or more example electronic devices, the controller circuitry 302A comprises any one or more of the following: a probability-integral-derivative, PID, controller, a proportional-integral, PI, controller, a proportional controller, and a cascade controller.

In one or more example electronic devices, the processor circuitry 302 is configured to obtain first secondary detection data from the detection circuitry. For example, the first secondary detection data may correspond to the next frame, capture or image after the frame, capture or image associated with the first primary detection data obtained from the detection circuitry, such as a first detection circuitry.

In one or more example electronic devices, the processor circuitry is configured to obtain, from the inference circuitry, a first secondary probability associated with the first secondary detection data, based on the first inference model. For example, the processor circuitry is configured to perform the operations disclosed herein.

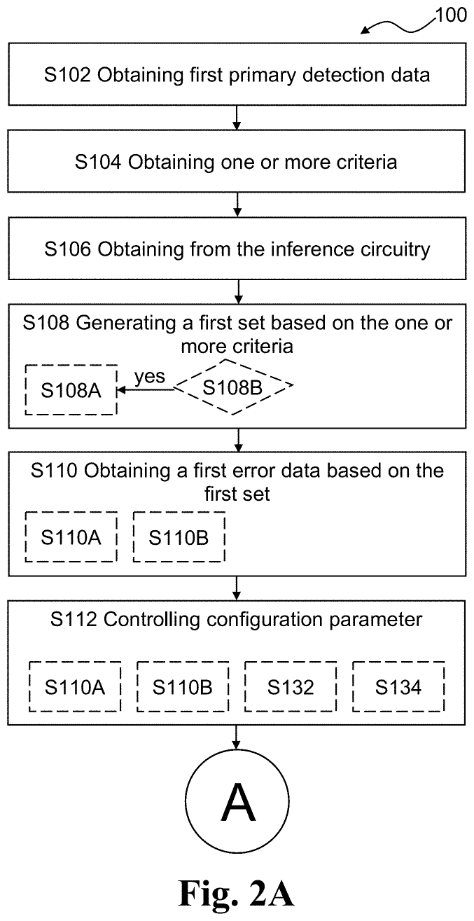

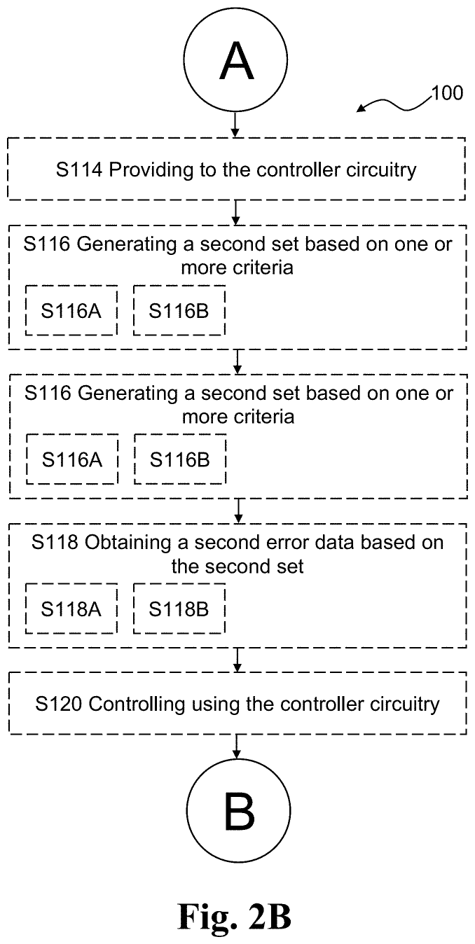

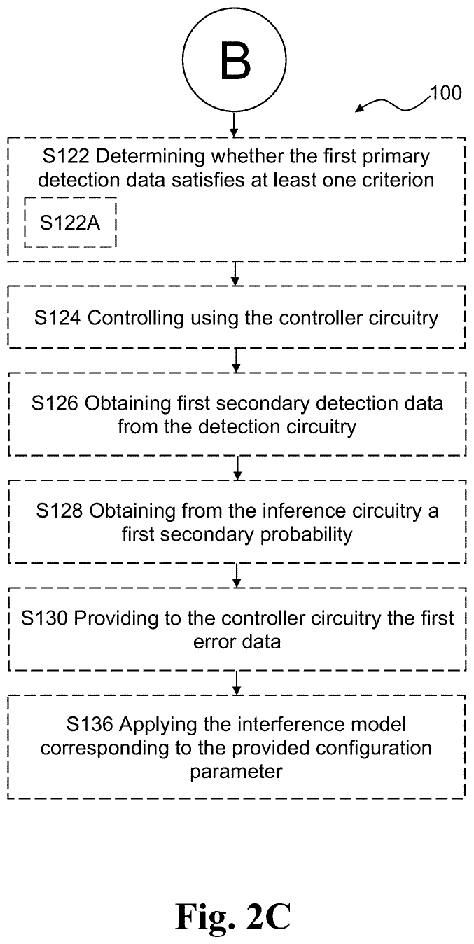

Furthermore, the operations of the electronic device 300 may be considered a method that the electronic device is configured to carry out (such as method 100 of FIGS. 2A-C). Also, while the described functions and operations may be implemented in software, such functionality may as well be carried out via dedicated hardware or firmware, or some combination of hardware, firmware and/or software.

FIG. 1B is a block diagram illustrating an example electronic device 300B according to some embodiments of the present disclosure. The electronic device 300B comprises a memory circuitry 301, an interface circuitry 303, and a processor circuitry 302. The processor circuitry 302 comprises a controller circuitry 302A and an inference circuitry 302B configured to operate according to a first inference model of a plurality of inference models. The processor circuitry 302 is configured to obtain first primary detection data from a detection circuitry 304B. The processor circuitry 302 is configured to obtain one or more criteria. The processor circuitry 302 is configured to obtain, from the inference circuitry, a first primary probability associated with the first primary detection data, based on the first inference model. The processor circuitry 302 is configured to generate a first set, based on the one or more criteria, by determining whether the first primary probability associated with the first primary detection data satisfies at least one of the one or more criteria. The processor circuitry 302 is configured to obtain a first error data based on the first set. The processor circuitry 302 is configured to control, using the controller circuitry 302A, based on the first error data, a configuration parameter indicative of one of the plurality of inference models for provision to the inference circuitry 302B.

In one or more example electronic devices, the detector circuitry 304B is external to the electronic device 300B. In other words, the interface circuitry may be configured to connect the electronic device to the detector circuitry.

Furthermore, the operations of the electronic device 300B may be considered a method that the electronic device is configured to carry out (such as method 100 of FIGS. 2A-C). Also, while the described functions and operations may be implemented in software, such functionality may as well be carried out via dedicated hardware or firmware, or some combination of hardware, firmware and/or software.

FIGS. 2A-C show flow diagrams of an example method 100 for controlling a configuration parameter for an electronic device according to the disclosure (such as the electronic device disclosed herein, such as any of electronic device 300A, 300B of FIGS. 1A-B). The electronic device comprises a memory circuitry, an interface circuitry, and a processor circuitry comprising a controller circuitry, an inference circuitry configured to operate according to a plurality of inference models comprising a first inference model.

The method 100 comprises obtaining S102 first primary detection data from a detection circuitry. The method 100 comprises obtaining S104 one or more criteria.

The method comprises obtaining S106, from the inference circuitry, a first primary probability associated with the first primary detection data, based on the first inference model.

The method comprises generating S108 a first set, based on the one or more criteria, by, inter alia, determining S108B whether the first primary probability associated with the first primary detection data satisfies at least one of the one or more criteria. For example, in one or more embodiments, generating S108 the first set, based on the one or more criteria comprises determining S108B whether the first primary probability associated with the first primary detection data satisfies at least one of the one or more criteria. For example, the electronic device may be configured to generate the first set, upon determining that the first primary probability associated with the first primary detection data satisfies at least one of the one or more criteria.

The method comprises obtaining S110 a first error data based on the first set. For example, the electronic device may be configured to obtain or generate the first error data based on the first set, upon determining that the first primary probability associated with the first primary detection data satisfies at least one of the one or more criteria.

The method comprises controlling S112, using the controller circuitry, based on the first error data, a configuration parameter indicative of one of the plurality of inference models for provision to the inference circuitry.

In one or more example methods, generating S108 the first set comprises populating S108A the first set for each first primary probability satisfying the at least one of the one or more criteria. For example, populating S108A the first set for each first primary probability satisfying the at least one of the one or more criteria may be performed upon determining that the first primary probability associated with the first primary detection data satisfies at least one of the one or more criteria.

In one or more example methods, the one or more criteria are based on a probability threshold and a detection category.

In one or more example methods, the one or more criteria are based on a probability threshold.

In one or more example methods, the one or more criteria are based on a detection category.

In one or more example methods, obtaining S110 the first error data based on the first set comprises obtaining S110A the first error data in response to the populating S108A of the first set and based on the probability threshold and the first primary probability associated with the first set.

In one or more example methods, obtaining S110 the first error data based on the first set comprises obtaining S110B the first error data based on a difference between the probability threshold and a minimum first primary probability of the first set or a maximum first primary probability of the first set.

In one or more example methods, the method comprises providing S114, to the controller circuitry, the obtained S104 one or more criteria.

In one or more example methods, the configuration parameter is indicative of a complexity level of one of the plurality of inference models and/or indicative of an accuracy level of one of the plurality of inference models.

In one or more example methods, controlling S112 the configuration parameter is based on controlling S112A a number of layers associated with an inference model and a layer type of the inference model.

In one or more example methods, controlling S112 the configuration parameter is based on controlling S112A a number of layers associated with an inference model.

In one or more example methods, controlling S112 the configuration parameter is based on controlling S112A a number of layers associated with a layer type of the inference model.

In one or more example methods, controlling S112 the configuration parameter comprises controlling S112B one or more of the following layer types: a convolutional layer, a pooling layer, a feedforward layer, and a drop-out layer.

In one or more example methods, the method comprises generating S116, a second set, based on one or more criteria, by determining S116A whether the first primary probability associated with the first primary detection data does not satisfy the at least one of the one or more criteria. For example, upon determining that the first primary probability associated with the first primary detection data does not satisfy at least one of the one or more criteria, the second set may be generated.

In one or more example methods, generating S116 the second set comprises populating S116B the second set for each first primary probability not satisfying the at least one of the one or more criteria.

In one or more example methods, the method comprises obtaining S118 a second error data based on the second set.

In one or more example methods, obtaining S118 the second error data based on the second set comprises obtaining S118A the second error data in response to the populating S116B of the second set and based on the probability threshold and the first primary probability associated with the second set.

In one or more example methods, obtaining S118 the second error data based on the second set comprises obtaining S118B the second error data based on a difference between the probability threshold and a minimum first primary probability of the second set or a maximum first primary probability of the second set.

In one or more example methods, the method comprises controlling S120, using the controller circuitry, based on the second error data, a configuration parameter indicative of one of the plurality of inference models for provision to the inference circuitry.

In one or more example methods, the method comprises determining S122 whether the first primary detection data satisfies at least one criterion based on the detection category by determining S122A whether the first primary detection data is not indicative of a detection.

In one or more example methods, the method comprises controlling S124, using the controller circuitry, the configuration parameter indicative of one of the plurality of inference models with a decreased complexity level and/or a decreased accuracy level for provision at the inference circuitry upon determining that the first primary detection data is not indicative of a detection.

In one or more example methods, the controller circuitry comprises any one or more of the following: a probability-integral-derivative, PID, controller, a proportional-integral, PI, controller, a proportional controller, and a cascade controller.

In one or more example methods, the method comprises obtaining S126 first secondary detection data from the detection circuitry.

In one or more example methods, the method comprises obtaining S128, from the inference circuitry, a first secondary probability associated with the first secondary detection data, based on the first inference model.

In one or more example methods, the method comprises providing S130 to the controller circuitry the first error data.

In one or more example methods, controlling S112 the configuration parameter comprises determining S132, based on the first error data, the configuration parameter indicative of the one of the plurality of inference models.

In one or more example methods, controlling S112 the configuration parameter comprises providing S134 to the inference circuitry the configuration parameter. In one or more example methods, the method comprises applying S136 the inference model corresponding to the provided configuration parameter.

FIG. 3 is a schematic representation 400 illustrating an example where a configuration parameter is controlled according to one or more embodiments of this disclosure.

In this example, the detection circuitry is a camera configured to capture a first image 402 indicative of a first scene, a second image 404 indicative of a second scene, a third image 406 indicative of a third scene, a fourth image 408 indicative of a fourth scene, a fifth image 410 indicative of a fifth scene, and a sixth image 412 indicative of a sixth scene. In some embodiments, the images 402, 406, 408, 410, 412 are presented in chronological order.

Image 402 shows an empty scene with no person or object detected. The inference circuitry may operate according to a first inference model of lower complexity and lower power consumption as the first scene does not indicate any detection (such as in S122 of FIG. 2A-C).

Image 404 shows a second scene with a person. The inference circuitry may operate according to a first inference model of lower complexity, and determines a first primary probability 404A associated with first primary detection data of image 404, wherein the first primary probability indicates that the object detected corresponds to a car with 0.2 probability. The processor circuitry determines whether the first primary probability 404A of 0.2 associated with the first primary detection data satisfies at least one of the one or more criteria, such as below a probability threshold of 0.8. As the first primary probability 404A of 0.2 is below 0.8, the first primary probability 404A of 0.2 satisfies at least one of the one or more criteria.

The processor circuitry generates a first set based on the first primary probability satisfying the at least one criterion. The processor circuitry populates the first set with probability 0.2, and obtains a first error data based on the first set (first error data=0.8−0.2=0.6). The processor circuitry controls using the controller circuitry a configuration parameter indicative of a second inference model for provision to the inference circuitry, which is determined by the controller circuitry to select the second inference model with an increased complexity level and/or an increased accuracy level (to reduce the first error data).

Image 406 shows a third scene with a person. The inference circuitry may operate according to a second inference model of higher complexity than the first inference model, and determines a first primary probability 406A associated with first primary detection data of image 406, wherein the first primary probability indicates that the object detected corresponds to a person with 0.9 probability. The processor circuitry determines whether the first primary probability 406A of 0.9 associated with the first primary detection data satisfies at least one of the one or more criteria, such as below a probability threshold of 0.8. As the first primary probability 406A of 0.9 is above 0.8, the first primary probability 406A of 0.9 does not satisfy the at least one of the one or more criteria.

The processor circuitry generates a second set based on the first primary probability not satisfying the at least one criterion. The processor circuitry populates the second set with probability 0.9, and obtains a second error data based on the second set (second error data=0.8−0.9=−0.1). The processor circuitry controls using the controller circuitry a configuration parameter indicative of the third inference model for provision to the inference circuitry, which is determined by the controller circuitry to select a third inference model with a decreased complexity level and/or a decreased accuracy level (to reduce power consumption while keeping the accuracy performance acceptable).

Image 408 shows a fourth scene with 4 objects. The inference circuitry may operate according to a third inference model of lower complexity than the second inference model, and determines first primary probabilities 408A, 408B, 408C, 408D associated with first primary detection data of image 408, wherein the first primary probability 408A indicates that the object detected corresponds to a person with 0.9 probability. The first primary probability 408B indicates that the object detected corresponds to a car with 0.5 probability. The first primary probability 408C indicates that the object detected corresponds to a person with 0.85 probability. The first primary probability 408D indicates that the object detected corresponds to a tree with 0.7 probability. The processor circuitry determines whether the first primary probability 408A, 408B, 408C, 408D associated with the first primary detection data satisfies at least one of the one or more criteria, such as below a probability threshold of 0.8.

As the first primary probability 408B of 0.5 is below 0.8, the first primary probability 408B satisfies the at least one of the one or more criteria, and populates the first set.

As the first primary probability 408D of 0.7 is below 0.8, the first primary probability 408D of 0.7 satisfies the at least one of the one or more criteria, and populates the first set.

In other words, the first set includes 0.7 and 0.5.

As long as the size of the first set is non-zero, the processor continues to look for a more accurate inference model to be used at the inference circuitry. In other words, as long as there exists at least one first primary probability which is below the probability threshold, the processor continues to look for a more accurate inference model to be used at the inference circuitry.

The processor circuitry obtains a first error data based on the first set (first error data=0.8−0.7=−0.2 or error data=0.8−0.5=0.3). The processor circuitry controls using the controller circuitry a configuration parameter indicative of the fourth inference model for provision to the inference circuitry, which is determined by the controller circuitry to select a fourth inference model with an increased complexity level and/or an increased accuracy level (to reduce power consumption while maintaining an acceptable accuracy).

Image 410 shows a fifth scene with 4 objects. The inference circuitry may operate according to a fourth inference model of higher complexity than the third inference model. This may lead to an improved accuracy of the inference. The inference circuitry determines first primary probabilities 410A, 410B, 410C, 410D associated with first primary detection data of image 410, wherein the first primary probability 410A indicates that the object detected corresponds to a person with 0.93 probability. The first primary probability 410B indicates that the object detected corresponds to a person with 0.85 probability. The first primary probability 410C indicates that the object detected corresponds to a person with 0.95 probability. The first primary probability 410D indicates that the object detected corresponds to a person with 0.87 probability. The processor circuitry determines whether the first primary probability 410A, 410B, 410C, 410D associated with the first primary detection data satisfies at least one of the one or more criteria, such as below a probability threshold of 0.8.

As the first primary probabilities 410A, 410B, 410C, 410D are each above 0.8, each first primary probability 410A, 410B, 410C, 410D does not satisfy the at least one of the one or more criteria, and do not populate the first set, and thus the complexity level is not increased.

In some embodiments, the first primary probabilities 410A, 410B, 410C, 410D may populate the second set where the configuration parameter may be controlled to lower the complexity of the inference model, or possibly maintain the complexity level

Image 412 shows a sixth scene with no objects. For this capture, the configuration parameter may be controlled to lower the complexity of the inference model.

When the input complexity increases, for example when more people move in an image, the controller circuitry selects an increasingly complex inference model until the probability threshold has been reached.

When the scene is static, for example when there are no people the image, the controller circuitry selects a simpler inference model and in essence goes into an idle power mode.

In an environment that varies in complexity, the disclosed technique selects an inference mode of minimal complexity of an inference model in order to keep the power consumption as low as possible, while assuring that the inference model performance is kept at an acceptable level.

Additionally, by keeping the complexity of the inference model as low as possible, the inference speed or rate of detection runs faster. In scenes with many changes, this means that it becomes less probable that a detection is missed.

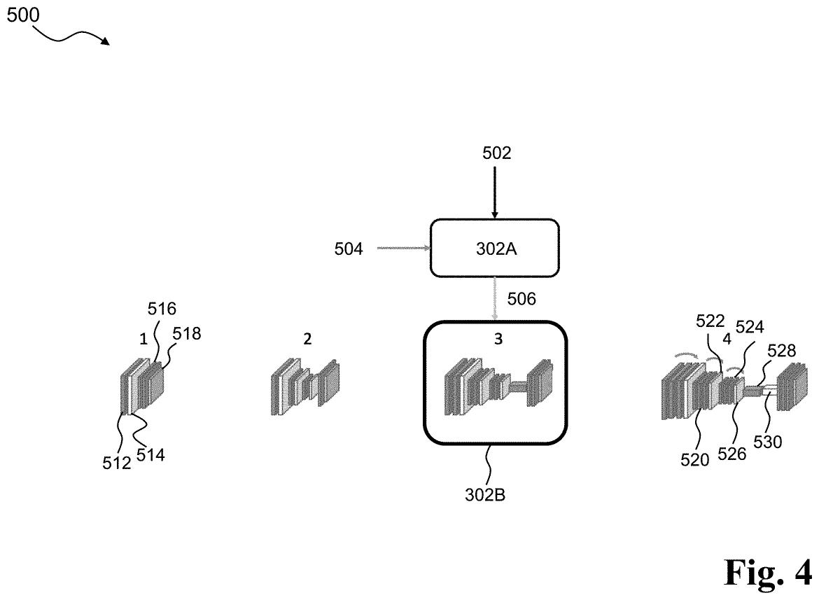

FIG. 4 is a schematic representation 500 illustrating an example process for controlling a configuration parameter for an electronic device according to one or more embodiments of this disclosure.

The controller circuitry 302A takes as input one or more criteria 502, such as a probability threshold, and one or more first primary probabilities 504 associated with the first primary detection data.

The controller circuitry 302A may determine the first error data based on the probability threshold, and the one or more first primary probabilities 504 associated with the first primary detection data. In other words, the controller circuitry 302A computes the first error data, such as a first error signal, from the inference model (such as the one or more first primary probabilities 504) output and a set threshold, such as the probability threshold.

The controller circuitry 302A provides as output a configuration parameter 506 that indicates an inference model, such as a kth inference model.

FIG. 4 shows a first inference mode 1 comprising a first layer of the first type 512, a second layer of the second type 514, two third layers of the third type 516, a fourth layer of the fourth type 518.

FIG. 4 shows a second inference mode 2 comprising various layers of various types.

FIG. 4 shows a third inference mode 3 comprising various layers of various types.

FIG. 4 shows a fourth inference mode 4 comprising layers of fifth type 520, layers of the sixth type 522, layers of the seventh type 524, layers of the eighth type 526, a layer of the ninth type 528, and a layer of the tenth type 530.

It may be appreciated that the inference models are presented in an order 1 to 4 of increasing complexity and of increasing accuracy. For example, the second inference model 2 is more complex and more accurate than the first inference model 1.

It may be appreciated that the inference models are presented in an order 1-4 of decreasing inference speed and of increasing power consumption. For example, the second inference model 2 is slower in inference speed and more power consuming than the first inference model 1. Inference speed may be seen as how fast the inference circuitry derives the one or more probabilities based on the inference model used by the inference circuitry. It may be appreciated that as the complexity level of the inference model increases, the accuracy of the inference may increase, the computational power may increase and the power consumption may increase while the inference speed may decrease. The present disclosure allows achieving acceptable accuracy, at acceptable power consumption and acceptable computational power by adapting the selection of the inference model based on one or more criteria.

Representation 500 illustrates the number of layers and types of layers that the controller circuitry may control via the configuration parameter. The type of layer may be characterized by a complexity level and/or a size.

Embodiments of methods and electronic devices according to the disclosure are set out in the following items:
1. An electronic device (300A, 300B) comprising:
   a memory circuitry (301);
   an interface circuitry (303);
   a processor circuitry (302) comprising a controller circuitry (302A), and an inference circuitry (302B) configured to operate according to a first inference model of a plurality of inference models;
   the processor circuitry (302) being configured to:
      obtain first primary detection data from a detection circuitry (304A, 304B);
      obtain one or more criteria;
      obtain, from the inference circuitry (302B), a first primary probability associated with the first primary detection data, based on the first inference model;
      generate a first set, based on the one or more criteria, by determining whether the first primary probability associated with the first primary detection data satisfies at least one of the one or more criteria;
      obtain a first error data based on the first set; and
      control, using the controller circuitry (302A), based on the first error data, a configuration parameter indicative of one of the plurality of inference models for provision to the inference circuitry (302B).
2. The electronic device according to item 1, wherein the generation of the first set is based on populating the first set for each first primary probability satisfying the at least one of the one or more criteria.
3. The electronic device according to any of items 1-2, wherein the one or more criteria are based on a probability threshold and/or a detection category.
4. The electronic device according to item 3, wherein the first error data is obtained in response to the populating of the first set and based on the probability threshold and the first primary probability associated with the first set.
5. The electronic device according to any of items 3-4, wherein the first error data is obtained based on a difference between the probability threshold and a minimum first primary probability of the first set or a maximum first primary probability of the first set.
6. The electronic device according to any of the previous items, wherein the processor is configured to provide the obtained one or more criteria to the controller circuitry.
7. The electronic device according to any of the previous items, wherein the configuration parameter is indicative of a complexity level of one of the plurality of inference models and/or indicative of an accuracy level of one of the plurality of inference models.
8. The electronic device according to any of the previous items as dependent on item 7, wherein the control of the configuration parameter indicative of the complexity level of one of the plurality of inference models is based on controlling a number of layers associated with an inference model and/or a layer type of the inference model.
9. The electronic device according to any of the previous items, wherein the control of the configuration parameter is based on one or more of the following layer types: a convolutional layer, a pooling layer, a feedforward layer, and a drop-out layer.
10. The electronic device according to any of items 6-9, wherein the processor circuitry is configured to generate a second set, based on one or more criteria, by determining whether the first primary probability associated with the first primary detection data does not satisfy the at least one of the one or more criteria.
11. The electronic device according to item 10, wherein the generation of the second set is based on populating the second set for each first primary probability not satisfying the at least one of the one or more criteria.
12. The electronic device according to any of items 11-12, wherein the processor circuitry is configured to obtain a second error data based on the second set.
13. The electronic device according to item 12, wherein the second error data is obtained in response to the populating of the second set and based on the probability threshold and the first primary probability associated with the second set.
14. The electronic device according to any of items 12-13, wherein the second error data is obtained based on a difference between the probability threshold and a minimum first primary probability of the second set or a maximum first primary probability of the second set.
15. The electronic device according to any of items 12-14, wherein the processor circuitry is configured to control, using the controller circuitry, based on the second error data, a configuration parameter indicative of one of the plurality of inference models for provision to the inference circuitry.
16. The electronic device according to any of the previous items as dependent on items 3 and/or 7, wherein the processor circuitry is configured to:
   determine whether the first primary detection data satisfies at least one criterion based on the detection category by determining whether the first primary detection data is not indicative of a detection, and
   control, using the controller circuitry, the configuration parameter indicative of one of the plurality of inference models with a decreased complexity level and/or a decreased accuracy level for provision at the inference circuitry upon determining that the first primary detection data is not indicative of a detection.
17. The electronic device according to any of the previous items, wherein the controller circuitry comprises any one or more of the following: a probability-integral-derivative, PID, controller, a proportional-integral, PI, controller, a proportional controller, and a cascade controller.
18. The electronic device according to any of the previous items, wherein the processor circuitry is configured to:
   obtain first secondary detection data from the detection circuitry; and
   obtain, from the inference circuitry, a first secondary probability associated with the first secondary detection data, based on the first inference model.
19. The electronic device according to any of the previous items, wherein the processor circuitry is configured to:
   obtain using the controller circuitry the first error data;
wherein the controller circuitry is configured to:
   determine, based on the first error data, the configuration parameter indicative of the one of the plurality of inference models;
   provide to the inference circuitry the configuration parameter; and
wherein the inference circuitry is configured to apply the inference model corresponding to the provided configuration parameter.
20. A method for controlling a configuration parameter for an electronic device comprising a memory circuitry, an interface circuitry, and a processor circuitry comprising a controller circuitry, an inference circuitry configured to operate according to a plurality of inference models comprising a first inference model, the method comprising:
   obtaining (S102) first primary detection data from a detection circuitry;
   obtaining (S104) one or more criteria;
   obtaining (S106), from the inference circuitry, a first primary probability associated with the first primary detection data, based on the first inference model;
   generating (S108) a first set, based on the one or more criteria, by determining whether the first primary probability associated with the first primary detection data satisfies at least one of the one or more criteria;
   obtaining (S110) a first error data based on the first set; and
   controlling (S112), using the controller circuitry, based on the first error data, a configuration parameter indicative of one of the plurality of inference models for provision to the inference circuitry.
21. Method according to item 20, wherein generating (S108) the first set comprises:
   populating (S108A) the first set for each first primary probability satisfying the at least one of the one or more criteria.
22. Method according to any of items 20-21, wherein the one or more criteria are based on a probability threshold and/or a detection category.
23. Method according to any of items 20-22 as dependent on item 21, wherein obtaining (S110) the first error data based on the first set comprises:
   obtaining (S110A) the first error data in response to the populating (S108A) of the first set and based on the probability threshold and the first primary probability associated with the first set.
24. Method according to any of items 20-23, wherein obtaining (S110) the first error data based on the first set comprises:
   obtaining (S110B) the first error data based on a difference between the probability threshold and a minimum first primary probability of the first set or a maximum first primary probability of the first set.
25. Method according to any of items 20-24, the method comprising:
   providing (S114), to the controller circuitry, the obtained (S104) one or more criteria.
26. Method according to any of items 20-25, wherein the configuration parameter is indicative of a complexity level of one of the plurality of inference models and/or indicative of an accuracy level of one of the plurality of inference models.
27. Method according to any of items 20-26, wherein controlling (S112) the configuration parameter is based on controlling (S112A) a number of layers associated with an inference model and/or a layer type of the inference model.
28. Method according to any of items 20-27, wherein controlling (S112) the configuration parameter comprises controlling (S112B) one or more of the following layer types: a convolutional layer, a pooling layer, a feedforward layer, and a drop-out layer.
29. Method according to any of items 20-28, the method comprising:
   generating (S116), a second set, based on one or more criteria, by determining (S116A) whether the first primary probability associated with the first primary detection data does not satisfy the at least one of the one or more criteria.
30. Method according to item 29, wherein generating (S116) the second set comprises:
   populating (S116B) the second set for each first primary probability not satisfying the at least one of the one or more criteria.
31. Method according to any of items 20-30, the method comprising:
   obtaining (S118) a second error data based on the second set.
32. Method according to item 31, wherein obtaining (S118) the second error data based on the second set comprises:
   obtaining (S118A) the second error data in response to the populating (S116B) of the second set and based on the probability threshold and the first primary probability associated with the second set.
33. Method according to any of items 31-32, wherein obtaining (S118) the second error data based on the second set comprises:
   obtaining (S118B) the second error data based on a difference between the probability threshold and a minimum first primary probability of the second set or a maximum first primary probability of the second set.
34. Method according to any of the previous items 20-33, the method comprising:
   controlling (S120), using the controller circuitry, based on the second error data, a configuration parameter indicative of one of the plurality of inference models for provision to the inference circuitry.
35. Method according to any of the previous items 20-34 as dependent on items 22 and/or 26, the method comprising:
   determining (S122) whether the first primary detection data satisfies at least one criterion based on the detection category by determining (S122A) whether the first primary detection data is not indicative of a detection, and
   controlling (S124), using the controller circuitry, the configuration parameter indicative of one of the plurality of inference models with a decreased complexity level and/or a decreased accuracy level for provision at the inference circuitry upon determining that the first primary detection data is not indicative of a detection.
36. Method according to any one of items 20-35, wherein the controller circuitry comprises any one or more of the following: a probability-integral-derivative, PID, controller, a proportional-integral, PI, controller, a proportional controller, and a cascade controller.
37. Method according to any of the previous items 20-36, the method comprising:
   obtaining (S126) first secondary detection data from the detection circuitry, and
   obtaining (S128), from the inference circuitry, a first secondary probability associated with the first secondary detection data, based on the first inference model.
38. Method according to any of the previous items 20-37, the method comprising:
   providing (S130) to the controller circuitry the first error data;
wherein controlling (S112) the configuration parameter comprises:
   determining (S132), based on the first error data, the configuration parameter indicative of the one of the plurality of inference models;
   providing (S134) to the inference circuitry the configuration parameter; and
wherein the method comprises:
   applying (S136) the inference model corresponding to the provided configuration parameter.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1A-4 comprises some circuitries or operations which are illustrated with a solid line and some circuitries or operations which are illustrated with a dashed line. The circuitries or operations which are comprised in a solid line are circuitries or operations which are comprised in the broadest example embodiment. The circuitries or operations which are comprised in a dashed line are example embodiments which may be comprised in, or a part of, or are further circuitries or operations which may be taken in addition to the circuitries or operations of the solid line example embodiments. It should be appreciated that these operations need not be performed in order presented. Furthermore, it should be appreciated that not all of the operations need to be performed. The operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the subject matter disclosed herein, that the example embodiments may be implemented at least in part by means of both hardware and software, and that several “means”, “units” or “devices” may be represented by the same item of hardware.

The various example methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly to be regarded in an illustrative rather than restrictive sense. The claimed disclosure is intended to cover all alternatives, modifications, and equivalents.

What is claimed is:

1. An electronic device comprising:
a memory circuitry;
an interface circuitry; and
a processor circuitry comprising a controller circuitry , and an inference circuitry configured to operate according to a first inference model of a plurality of inference models;
the processor circuitry being configured to:
obtain first primary detection data from a detection circuitry;
obtain one or more criteria;
obtain, from the inference circuitry , a first primary probability associated with the first primary detection data, based on the first inference model;
generate a first set, based on the one or more criteria, by determining whether the first primary probability associated with the first primary detection data satisfies at least one of the one or more criteria, wherein the generation of the first set is based on populating the first set for each first primary probability satisfying the at least one of the one or more criteria;
obtain a first error data based on the first set; and
control, using the controller circuitry, based on the first error data, a configuration parameter indicative of one of the plurality of inference models for provision to the inference circuitry.

2. The electronic device according to claim 1, wherein the one or more criteria are based on a probability threshold and/or a detection category.

3. The electronic device according to claim 2, wherein the first error data is obtained in response to the populating of the first set and based on the probability threshold and the first primary probability associated with the first set.

4. The electronic device according to claim 2, wherein the first error data is obtained based on a difference between the probability threshold and a minimum first primary probability of the first set or a maximum first primary probability of the first set.

5. The electronic device according to claim 1, wherein the processor circuitry is configured to provide the obtained one or more criteria to the controller circuitry.

6. The electronic device according to claim 1, wherein the configuration parameter is indicative of a complexity level of one of the plurality of inference models and/or indicative of an accuracy level of one of the plurality of inference models.

7. The electronic device according to claim 1, wherein the configuration parameter is indicative of a complexity level of one of the plurality of inference models.

8. The electronic device according to claim 7, wherein the control of the configuration parameter indicative of the complexity level of one of the plurality of inference models is based on controlling a number of layers associated with an inference model and/or a layer type of the inference model.

9. The electronic device according to claim 1, wherein the control of the configuration parameter is based on one or more of the following layer types: a convolutional layer, a pooling layer, a feedforward layer, and a drop-out layer.

10. The electronic device according to claim 2, wherein the configuration parameter is indicative of a complexity level of one of the plurality of inference models and/or indicative of an accuracy level of one of the plurality of inference models.

11. The electronic device according to claim 10, wherein the processor circuitry is configured to:
determine whether the first primary detection data satisfies at least one criterion based on the detection category by determining whether the first primary detection data is not indicative of a detection, and
control, using the controller circuitry, the configuration parameter indicative of one of the plurality of inference models with a decreased complexity level and/or a decreased accuracy level for provision at the inference circuitry upon determining that the first primary detection data is not indicative of a detection.

12. The electronic device according to claim 5, wherein the processor circuitry is configured to generate a second set, based on one or more criteria, by determining whether the first primary probability associated with the first primary detection data does not satisfy the at least one of the one or more criteria.

13. The electronic device according to claim 12, wherein the generation of the second set is based on populating the second set for each first primary probability not satisfying the at least one of the one or more criteria.

14. The electronic device according to claim 13, wherein the processor circuitry is configured to obtain a second error data based on the second set.

15. The electronic device according to claim 14, wherein the second error data is obtained in response to the populating of the second set and based on the probability threshold and the first primary probability associated with the second set.

16. The electronic device according to claim 14, wherein the second error data is obtained based on a difference between the probability threshold and a minimum first primary probability of the second set or a maximum first primary probability of the second set.

17. The electronic device according to claim 14, wherein the processor circuitry is configured to control, using the controller circuitry, based on the second error data, a configuration parameter indicative of one of the plurality of inference models for provision to the inference circuitry.

18. The electronic device according to claim 1, wherein the controller circuitry comprises any one or more of the following: a probability-integral-derivative, PID, controller, a proportional-integral, PI, controller, a proportional controller, and a cascade controller.

19. The electronic device according to claim 1, wherein the processor circuitry is configured to:
obtain first secondary detection data from the detection circuitry; and
obtain, from the inference circuitry, a first secondary probability associated with the first secondary detection data, based on the first inference model.

20. The electronic device according to claim 1, wherein the processor circuitry is configured to:
obtain using the controller circuitry the first error data;
wherein the controller circuitry is configured to:
determine, based on the first error data, the configuration parameter indicative of the one of the plurality of inference models; and
provide to the inference circuitry the configuration parameter; and
wherein the inference circuitry is configured to apply the inference model corresponding to the provided configuration parameter.
